(19) United States
(12) Patent Application Publication
(10) Pub. No.: US 2025/0298870 A1
(43) Pub. Date: Sep. 25, 2025

(54) SERVICE MANAGEMENT SYSTEM, SERVICE MANAGEMENT METHOD, AND NON-TRANSITORY COMPUTER READABLE MEDIUM

(71) Applicant: FUJIFILM Business Innovation Corp., Tokyo (JP)

(72) Inventor: Yasuto ISHIBASHI, Kanagawa (JP)

(73) Assignee: FUJIFILM Business Innovation Corp., Tokyo (JP)

(21) Appl. No.: 18/782,936

(22) Filed: Jul. 24, 2024

(30) Foreign Application Priority Data
Mar. 22, 2024 (JP) 2024-046397

(51) Int. Cl. G06F 21/10; H04N 1/00; H04N 1/44

(52) U.S. Cl. CPC G06F 21/1077; H04N 1/00413; H04N 1/4433; H04N 2201/0094

(57) ABSTRACT

A service management system includes at least one processor configured to: acquire a usage term of a service related to an image processing apparatus; acquire stopped function information defined for each service, the stopped function information indicating which function, from among functions related to the service, is to be stopped when the usage term expires; and stop, when the usage term of the service expires, usage of the function included in the stopped function information defined for the service with the expired usage term.

### CROSS-REFERENCE TO RELATED APPLICATIONS

This application is based on and claims priority under 35 USC 119 from Japanese Patent Application No. 2024-046397 filed Mar. 22, 2024.

### BACKGROUND

### (i) Technical Field

The present disclosure relates to a service management system, a service management method, and a non-transitory computer readable medium.

### (ii) Related Art

Japanese Unexamined Patent Application Publication No. 2014-078270 discloses a management apparatus including: a renewal setting instruction unit that stops automatic renewal of a software license when a notification of license expiration is received from an image forming apparatus; a payment information acquisition and renewal unit that acquires payment information indicating payment or non-payment of a fee; a renewability determination unit that determines that the license is renewable when it is confirmed that the fee has been paid; and a renewal request unit that transmits a renewal request to the image forming apparatus when it is determined that the license is renewable.

There are known mechanisms for purchasing and exercising usage rights to products or services for fixed periods. For example, with image processing apparatuses, there are mechanisms for contracting additional services according to user needs on top of a basic standard contract. In general, if a service renewal procedure is not performed during the usage term of a service, the service is stopped temporarily after the end of the usage term until the renewal procedure is performed. Thereafter, if the renewal procedure is performed, the service is resumed. However, if a service is stopped temporarily and then resumed after a renewal procedure, an event that occurred while the service was stopped may not be affected. For example, in the case of a service that sorts documents received by facsimile into folders according to the sender, if the service is stopped temporarily, sorting may not occur for documents received while the service was stopped, even if the service is resumed.

### SUMMARY

Aspects of non-limiting embodiments of the present disclosure relate to facilitating the continuation of services as compared to the case in which functions related to services are stopped indiscriminately when a renewal procedure is not completed by the end of the usage term of the services.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a service management system including at least one processor configured to: acquire a usage term of a service related to an image processing apparatus; acquire stopped function information defined for each service, the stopped function information indicating which function, from among functions related to the service, is to be stopped when the usage term expires; and stop, when the usage term of the service expires, usage of the function included in the stopped function information defined for the service with the expired usage term.

### BRIEF DESCRIPTION OF THE DRAWINGS

Exemplary embodiments of the present disclosure will be described in detail based on the following figures, wherein:

FIG. 1 is a diagram illustrating an example of a configuration of a service providing system to which an exemplary embodiment is applied;

FIG. 2 is a diagram illustrating an example of a hardware configuration of an image processing apparatus;

FIG. 3 is a diagram illustrating an example of a hardware configuration of a lock server;

FIG. 4 is a diagram illustrating an example of a functional configuration of a lock server and a functional configuration of an image processing apparatus;

FIG. 5 is a diagram illustrating an example of a usage term table managed by a service usage term storage unit;

FIG. 6 is a diagram illustrating an example of a lock details table managed by a lock details storage unit;

FIG. 7 is a sequence diagram illustrating an example of a process by an image processing apparatus and a lock server;

FIG. 8 is a flowchart illustrating an example of a process for periodically checking a usage term;

FIG. 9 is a diagram illustrating an example of a lock details table according to exemplary modification 1;

FIG. 10 is a flowchart illustrating an example of a process for periodically checking a usage term according to exemplary modification 1;

FIG. 11 is a diagram illustrating an example of a lock details table according to exemplary modification 2;

FIG. 12 is a flowchart illustrating an example of a process whereby an image processing apparatus locks a function upon expiration of the usage term of a service;

FIG. 13 is a diagram illustrating an example of a hardware configuration of an image processing apparatus according to a second exemplary embodiment;

FIG. 14 is a diagram illustrating an example of functional configurations of an image processing apparatus and a lock server according to a second exemplary embodiment;

FIG. 15 is a diagram illustrating an example of a lock details table according to a second exemplary embodiment;

FIG. 16 is a flowchart illustrating an example of a process for periodically checking a usage term;

FIG. 17 is a diagram illustrating an example of the flow of a process whereby a lock is applied to a newly logged-in user when the logged-in user changes;

FIGS. 18A and 18B are each a diagram illustrating an example of a display on an operation panel; and

FIG. 19 is a diagram illustrating an example of a display on an operation panel.

### DETAILED DESCRIPTION

Hereinafter, exemplary embodiments of the present disclosure will be described in detail and with reference to the attached drawings.

### First Exemplary Embodiment

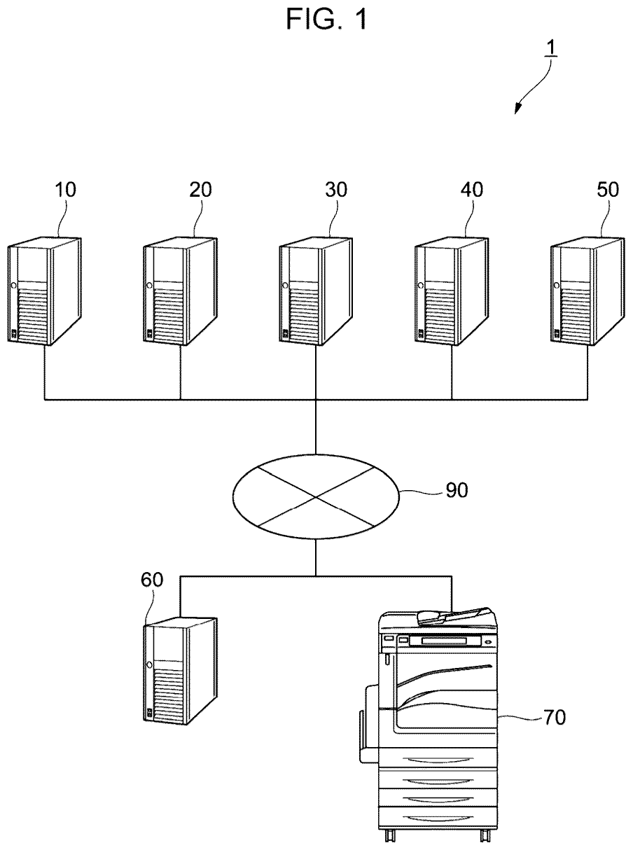

FIG. 1 is a diagram illustrating a configuration of a service providing system 1 to which a first exemplary embodiment is applied. The service providing system 1 includes a reception server 10, a deposit server 20, a maintenance management server 30, an application server 40, a lock server 50, a management server 60, and an image processing apparatus 70. Note that the reception server 10, deposit server 20, maintenance management server 30, application server 40, and lock server 50 are servers provided on the side that provides services. These servers provided on the side that provides services are achieved by a server machine such as a computer apparatus, but the number of server machines is not limited.

The management server 60 and the image processing apparatus 70 connect to the reception server 10, maintenance management server 30, application server 40, and lock server 50 over a network 90. The management server 60 and the image processing apparatus 70 are an example of a service management system. The image processing apparatus 70 is what is called a multi-function peripheral provided with a print function, a scanner function, and a facsimile function. Note that the image processing apparatus 70 is not limited to a multi-function peripheral with multiple functions, and may also be a printer apparatus with a print function or a scanner apparatus with a scanner function, for example. The image processing apparatus 70 may receive additional services according to user needs, on top of a standard contract, as services related to the image processing apparatus 70. The additional services become usable if a user purchases usage rights for a fixed period. For the user to continue using the services after the fixed period expires, a renewal procedure is performed to extend the usage term.

The management server 60 is a server that manages the image processing apparatus 70. Hereinafter, the present exemplary embodiment is described as though the image processing apparatus 70 itself manages the services contracted by the image processing apparatus 70. However, some or all of the functions executed by the image processing apparatus 70 may also be executed by the management server 60.

The reception server 10 is a web server that accepts applications for additional services from the user. In regard to additional services, the reception server 10 accepts an application for a new contract procedure and an application for a renewal procedure. Note that the procedure of application for additional services is not limited to being performed via the reception server 10. The procedure of application for additional services may include, for example, the user filling in relevant items on a contract form printed by the image processing apparatus 70 and sending the completed form through the mail or by facsimile.

The deposit server 20 generates information indicating that an application procedure has been completed when a deposit is received from the user who has applied to purchase usage rights to a service.

The maintenance management server 30 provides maintenance services related to maintenance management of the image processing apparatus 70. For example, the maintenance management server 30 performs a process for automatically delivering consumables used in the image processing apparatus 70. As another example, the maintenance management server 30 performs a process for dispatching a maintenance worker to perform maintenance or repair of the image processing apparatus 70. To accomplish this, the maintenance management server 30 may acquire information indicating the state of the image processing apparatus 70 from the image processing apparatus 70. The information indicating the state of the image processing apparatus 70 may be, for example, the value of a sensor provided in the image processing apparatus 70. The information indicating the state of the image processing apparatus 70 may also be, for example, the number of sheets of recording media that the image processing apparatus 70 has printed.

The application server 40 stores software for various applications provided to the image processing apparatus 70, and delivers the software to the image processing apparatus 70. The applications stored in the application server 40 include applications that expand the functionality of the image processing apparatus 70. If the user purchases usage rights to a service for expanding the functionality of the image processing apparatus 70, an application for executing the service is delivered to the image processing apparatus 70 from the application server 40. A service for expanding functionality via an application is one example of a function expansion service.

The lock server 50 stores the usage terms of various services and information indicating functions to be stopped when the usage terms of the various services expire. Hereinafter, the information indicating functions to be stopped may be referred to as lock details. In response to a request from the image processing apparatus 70, the lock server 50 transmits usage terms and lock details stored in the lock server 50 to the image processing apparatus 70.

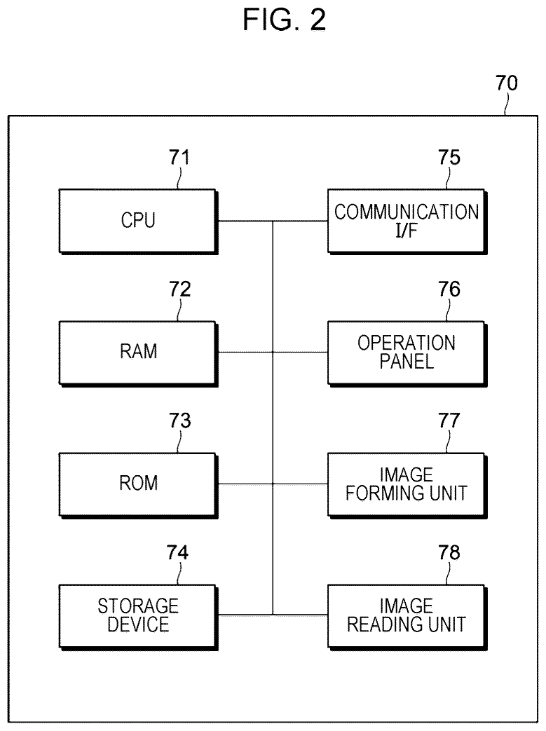

FIG. 2 is a diagram illustrating an example of a hardware configuration of the image processing apparatus 70. The image processing apparatus 70 includes a central processing unit (CPU) 71, random access memory (RAM) 72, read-only memory (ROM) 73, and a storage device 74. The CPU 71 is one example of a processor that controls the image processing apparatus 70 overall. When a control program is executed by the CPU 71, functional units of the image processing apparatus 70 are controlled. The RAM 72 is used as a work area for the CPU 71 to perform computation. The ROM 73 is a memory in which, for instance, various programs to be executed by the CPU 71 are recorded. The storage device 74 stores various settings used for control of the image processing apparatus 70, image information to be used in printing, and the like. A hard disk drive (HDD), semiconductor memory, or the like may be used as the storage device 74.

The image processing apparatus 70 is also provided with a communication interface (hereinafter referred to as the “communication I/F”) 75 and an operation panel 76. The communication I/F 75 transmits and receives data over the network 90 (see FIG. 1). The operation panel 76 displays various information and accepts operation input from the user. The operation panel 76 is an example of a display device, and is a touch panel, for example.

The image processing apparatus 70 is further provided with an image forming unit 77 and an image reading unit 78. The image forming unit 77 is a printing mechanism that forms an image onto a recording medium. The image reading unit 78 reads an image recorded on a document.

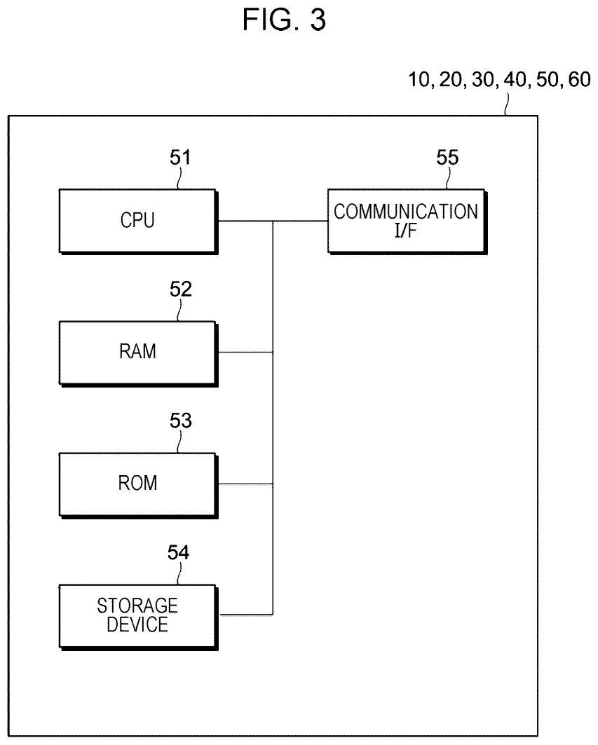

FIG. 3 is a diagram illustrating an example of a hardware configuration of each server. The reception server 10, deposit server 20, maintenance management server 30, application server 40, lock server 50, and management server 60 have similar hardware configurations.

Each server is provided with a CPU 51, RAM 52, ROM 53, a storage device 54, and a communication I/F 55. The CPU 51 controls each of the servers. When a control program is executed by the CPU 51, functional units of each of the servers are controlled. The RAM 52 is used as a work area for the CPU 51 to perform computation. The ROM 53 is a memory in which, for instance, various programs to be executed by the CPU 51 are recorded. The storage device 54 stores various information. The communication I/F 55 connects to and communicates with other apparatuses.

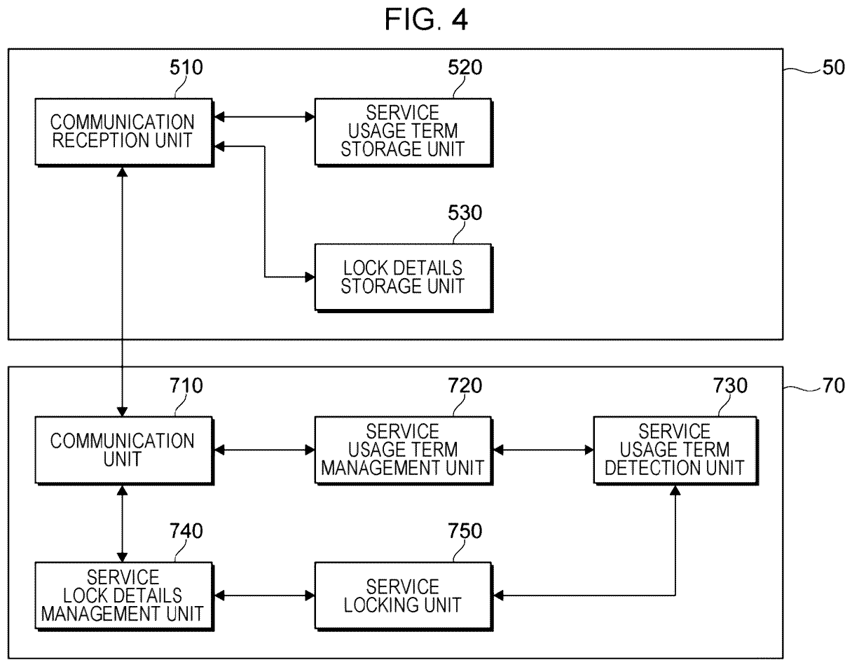

FIG. 4 is a diagram illustrating a functional configuration of the lock server 50 and a functional configuration of the image processing apparatus 70. First, the functional configuration of the lock server 50 will be described. The lock server 50 is provided with a communication reception unit 510, a service usage term storage unit 520, and a lock details storage unit 530.

The communication reception unit 510 accepts a communication request from the image processing apparatus 70 and communicates with the image processing apparatus 70. Note that the communication reception unit 510 may be configured to communicate with the image processing apparatus 70 only if a communication request is received from the image processing apparatus 70. The communication reception unit 510 may also be configured to send a communication request from the lock server 50 to the image processing apparatus 70.

The service usage term storage unit 520 causes the storage device 54 (see FIG. 3) to store a usage term of each service that the image processing apparatus 70 is using. The service usage term storage unit 520 acquires the usage terms of services from the reception server 10 (see FIG. 1). The service usage term storage unit 520 also acquires, from the deposit server 20 (see FIG. 1), information indicating that money for purchasing service usage rights has been deposited. When a renewal procedure for a service is completed, the service usage term storage unit 520 renews the usage term of that service. The service usage term storage unit 520 causes the storage device 54 to store a date indicating the usage term of a service in association with a service name, which is information for identifying the service.

The lock details storage unit 530 causes the storage device 54 (see FIG. 3) to store information indicating a function of which usage is to be stopped when the usage term expires from among functions related to services provided by the service providing system 1. The information indicating a function of which usage is to be stopped when the usage term expires from among functions related to services is hereinafter referred to as “lock details”. The lock details are an example of stopped function information. The lock details are determined in advance by the service provider. The lock details storage unit 530 stores lock details for each service provided by the service providing system 1. Specifically, the lock details storage unit 530 causes the storage device 54 to store lock details in association with a service name, for example.

Next, the functional configuration of the image processing apparatus 70 will be described. The image processing apparatus 70 is provided with a communication unit 710, a service usage term management unit 720, a service usage term detection unit 730, a service lock details management unit 740, and a service locking unit 750.

The communication unit 710 transmits a connection request to the lock server 50 and communicates with the lock server 50.

The service usage term management unit 720 acquires the service usage term stored for each service from the lock server 50 and causes the storage device 74 (see FIG. 2) to store the acquired usage term. The service usage term management unit 720 acquires the service usage term from the lock server 50 at a predetermined timing or in response to a user instruction. The predetermined timing is a regularly scheduled timing, such as once a day, for example.

The timing at which to acquire the service usage term may also be configured to change depending on the circumstances. For example, it is conceivable to obtain the service usage term more frequently during a period when the service usage term is considered likely to fluctuate. The period when the service usage term is considered likely to fluctuate is, for example, the period after the service usage term expires. That is, when the usage term expires, the service usage term management unit 720 may shorten the cycle for acquiring the usage term. Specifically, for example, in the case where the frequency for acquiring the service usage term is once a day, the service usage term management unit 720 acquires the service usage term hourly for the first five days after the service usage term expires.

Also, one example of “in response to a user instruction” may be when the user makes a request to renew the service usage term via the operation panel 76 (see FIG. 2) of the image processing apparatus 70.

The service usage term detection unit 730 detects whether the usage term stored by the service usage term management unit 720 is expired. The service usage term detection unit 730 detects whether the usage term is expired at a predetermined timing or in response to a user instruction. One example of the predetermined timing may be the timing at which the date changes, such as at midnight. As another example, in the case where the service usage term management unit 720 is acquiring the usage term more frequently, the service usage term detection unit 730 may be configured to detect the usage term at the timing when the service usage term management unit 720 acquires the usage term.

The service lock details management unit 740 acquires lock details for each service from the lock server 50 and causes the storage device 74 (see FIG. 2) to store the acquired lock details. The service lock details management unit 740 may acquire only the lock details of services contracted by the image processing apparatus 70 itself, or acquire lock details including the lock details of services not contracted by the image processing apparatus 70 itself. The service lock details management unit 740 acquires lock details at a predetermined timing. Examples of the predetermined timing in this case include when the image processing apparatus 70 is newly installed or the timing at which the usage term expires. As another example, the predetermined timing may coincide with the timing at which the service usage term management unit 720 acquires the usage term, such that the usage term and the lock details are acquired together.

The service locking unit 750 controls the stopping of the functions of the image processing apparatus 70. When the service usage term expires, the service locking unit 750 stops usage of the function included in the lock details defined for the service with the expired usage term. More specifically, the service locking unit 750 references the lock details stored in the storage device 74 and stops usage of the function included in the lock details. Additionally, if a renewal procedure is completed for a service with the expired usage term after usage of the function included in the lock details is stopped, the service locking unit 750 cancels the control to stop the function and resumes the stopped function.

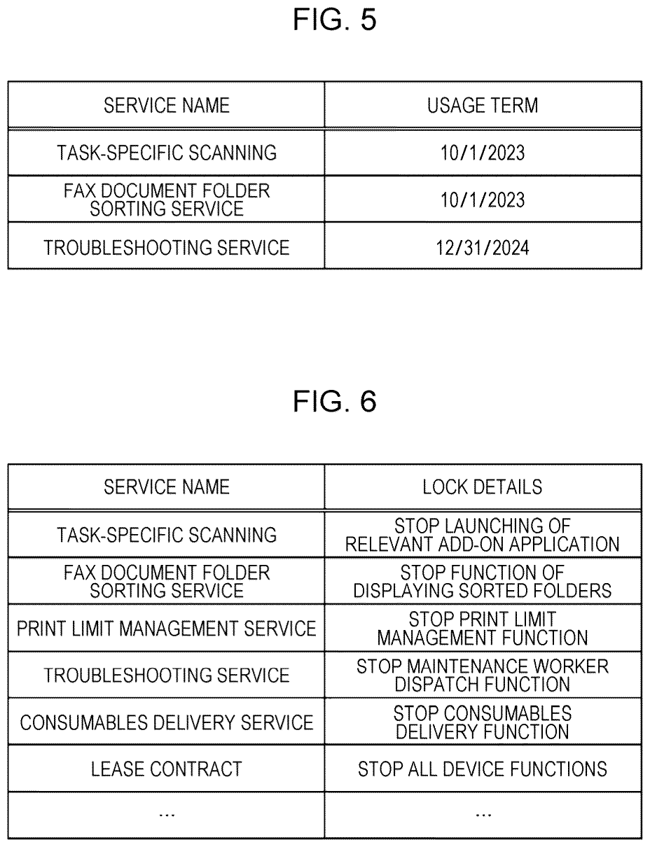

FIG. 5 is a diagram illustrating an example of a usage term table managed by the service usage term storage unit 520. In the usage term table, a usage term is stored for each service contracted by the image processing apparatus 70. Specifically, a date is stored as the usage term in association with a service name identifying the service. More specifically, Oct. 1, 2023 is stored as the usage term in association with the service with the service name “Task-specific scanning”. Also, Oct. 1, 2023 is stored as the usage term in association with the service with the service name “Fax document folder sorting service”. Furthermore, Dec. 31, 2024 is stored as the usage term in association with the service with the service name “Troubleshooting service”.

FIG. 6 is a diagram illustrating an example of a lock details table managed by the lock details storage unit 530. In the lock details table, a service name and lock details are stored in association with one another. Specifically, for the service “Task-specific scanning”, “Stop launching of relevant add-on application” is indicated as the lock details. Note that “Stop launching of relevant add-on application” means to stop the launching of an expansion application provided to make task-specific scanning available for use.

Also, for the “Fax document folder sorting service”, “Stop function of displaying sorted folders” is indicated. Note that “Stop function of displaying sorted folders” means carrying out control to sort fax documents received while the usage term is expired, but not to display the folders that the fax documents are sorted into. Also, for the “Print limit management service”, “Stop print limit management” is indicated as the lock details.

Also, for the “Troubleshooting service”, “Stop maintenance worker dispatch function” is indicated as the lock details. Note that in the “Troubleshooting service”, the maintenance management server 30 dispatches a maintenance worker on the basis of information acquired from the image processing apparatus 70. In this case, the lock details “Stop maintenance worker dispatch function” may mean that the image processing apparatus 70 transmits information causing the maintenance management server 30 to stop the maintenance worker dispatch function.

Also, for the “Consumables delivery service”, “Stop consumables delivery function” is indicated as the lock details. Note that in the “Consumables delivery service”, the maintenance management server 30 delivers consumables on the basis of information acquired from the image processing apparatus 70. In this case, the lock details “Stop consumables delivery function” may mean that the image processing apparatus 70 transmits information causing the maintenance management server 30 to stop the consumables delivery function.

Also, for “Lease contract”, “Stop all device functions” is indicated as the lock details.

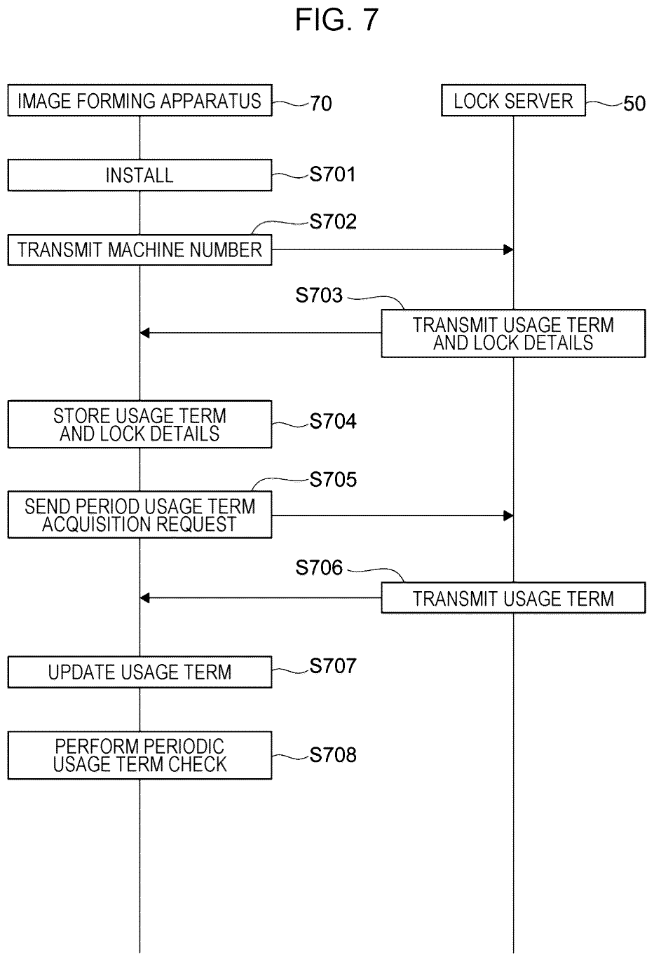

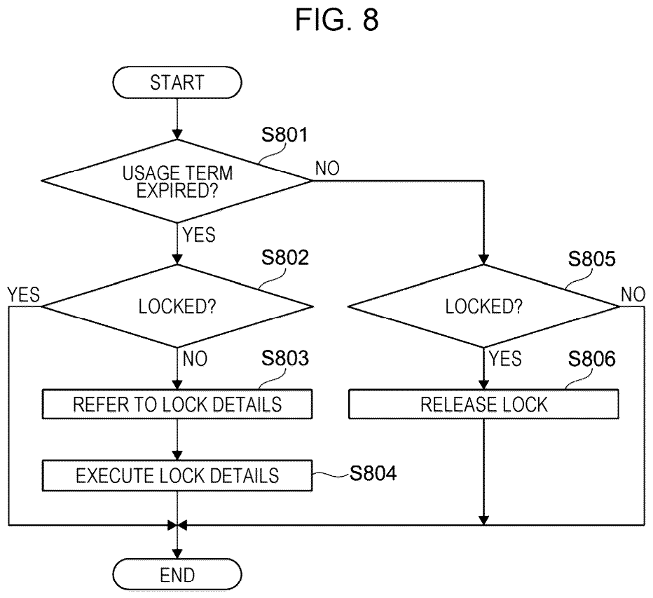

FIG. 7 is a sequence diagram illustrating a process by the image processing apparatus 70 and the lock server 50. Various initial settings are set when the image processing apparatus 70 is newly installed, and the image processing apparatus 70 is connected to the lock server 50 (step 701). Additionally, the image processing apparatus 70 transmits a machine number of the image processing apparatus 70 to the lock server 50 (step 702). Note that the machine number of the image processing apparatus 70 is used as information for identifying the image processing apparatus 70. Upon acquiring the machine number from the image processing apparatus 70, the lock server 50 transmits the usage term and lock details of a service contracted by the image processing apparatus 70 to the image processing apparatus 70 (step 703). Upon acquiring the usage term and lock details of a service from the lock server 50, the image processing apparatus 70 causes the storage device 74 (see FIG. 2) of the image processing apparatus 70 to store the acquired usage term and lock details (step 704).

The image processing apparatus 70 periodically makes a request to the lock server 50 to acquire the usage term (step 705). The lock server 50 transmits the usage term stored in the lock server 50 to the image processing apparatus 70 (step 706). Upon acquiring the usage term from the lock server 50, the image processing apparatus 70 updates the usage term stored in the storage device 74 (step 707).

Also, the image processing apparatus 70 performs a periodic check of the usage term when a predetermined time is reached (step 708). The periodic check of the usage term will be described using FIG. 8.

FIG. 8 is a flowchart illustrating an example of a process for periodically checking the usage term. The CPU 71 (see FIG. 2) of the image processing apparatus 70 refers to the usage term table stored in the storage device 74 (see FIG. 2) of the image processing apparatus 70, and determines whether or not the usage term of a service is expired (step 801). If the usage term of a service is expired (step 801, YES), the CPU 71 determines whether or not the service is already locked (step 802). If the service with the expired usage term is not locked (step 802, NO), the CPU 71 references the lock details associated with the service with the expired usage term (step 803). The CPU 71 then executes the referenced lock details (step 804), and the process ends.

If it is determined in step 802 that the service with the expired usage term is already locked (step 802, YES), the process ends immediately.

Also, if it is determined in step 801 that the usage term is not expired (step 801, NO), the CPU 71 determines whether or not the service is locked (step 805). If it is determined that the service is not locked (step 805, NO), the process ends immediately. If it is determined that the service is locked (step 805, YES), the CPU 71 releases the lock (step 806), and the process ends. Note that the situation where the service is determined to be locked in step 805 may occur when, for example, the usage term of the service expires and the locking process is performed, after which a service renewal procedure is completed and the usage term of the service is renewed.

### (Exemplary Modification 1)

The following describes exemplary modification 1, which is an exemplary modification of the first exemplary embodiment. In exemplary modification 1, rather than locking services with expired usage terms at indiscriminate timings, the timing at which to lock a service is defined for each service. In the lock details table (see FIG. 6) described above, lock details are stored in association with each service, but in exemplary modification 1, a lock grace period is further stored in association with each service. The lock grace period is a period determined in advance by the service provider, for example. The lock grace period is defined as the period after a service usage term expires until the locking of the service begins. In other words, the lock grace period is the period until functions are stopped after a usage term expires. The lock grace period is an example of stopped function information. The lock grace period may be a different period for each service, and for example, the lock grace period of a maintenance service may be longer than the lock grace period of a function expansion service. In other words, a longer lock grace period may be set for a maintenance service than for a function expansion service.

The lock details table according to exemplary modification 1 is stored in the storage device 54 (see FIG. 3) of the lock server 50 (see FIG. 3). The service lock details management unit 740 (see FIG. 4) of the image processing apparatus 70 (see FIG. 4) acquires the lock details table from the lock server 50. The lock details table is stored in the storage device 74 (see FIG. 2) of the image processing apparatus 70 by the service lock details management unit 740.

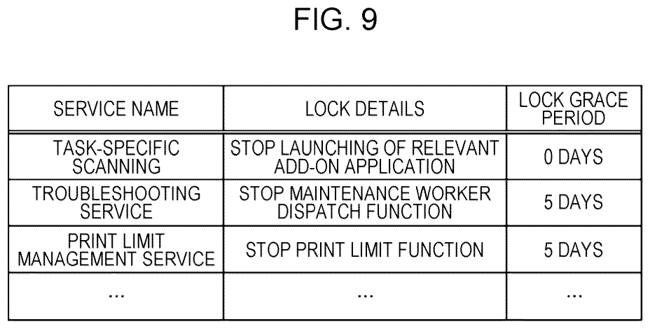

FIG. 9 is a diagram illustrating an example of the lock details table according to exemplary modification 1. In the lock details table according to exemplary modification 1, lock details and a lock grace period are stored in association with each service name. Specifically, for “Task-specific scanning”, “Stop launching of relevant add-on application” is associated as the lock details and “0 days” is associated as the lock grace period. For the “Troubleshooting service”, “Stop maintenance worker dispatch function” is associated as the lock details and “5 days” is associated as the lock grace period. Additionally, for “Print limit management”, “Stop print limit function” is associated as the lock details and “5 days” is associated as the grace period.

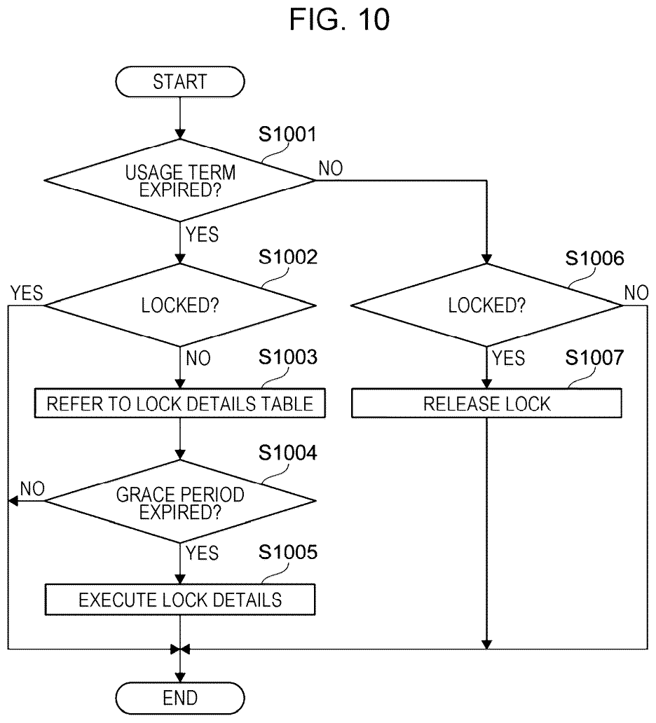

FIG. 10 is a flowchart illustrating an example of a process for periodically checking a usage term according to exemplary modification 1. The CPU 71 of the image processing apparatus 70 refers to the usage term table stored in the storage device 74 (see FIG. 2) of the image processing apparatus 70, and determines whether or not the usage term of a service is expired (step 1001). If the usage term of a service is expired (step 1001, YES), the CPU 71 determines whether or not the service is already locked (step 1002). If the service with the expired usage term is not locked (step 1002, NO), the CPU 71 refers to the lock details table associated with the service with the expired usage term (step 1003). The CPU 71 then determines whether or not the lock grace period is expired (step 1004). If the lock grace period is expired (step S1004, YES), the CPU 71 executes the lock details (step 1005), and the process ends.

In step 1004, if the grace period is not expired (step 1004, NO), the process ends immediately. Also, in step 1002, if the service with the expired usage term is already locked (step 1002, YES), the process ends immediately.

Also, in step 1001, if the usage term is not expired (step 1001, NO), the CPU 71 determines whether or not the service is already locked (step 1006). If the service is not locked (step 1006, NO), the process ends immediately. If the service is locked (step 1006, YES), the CPU 71 releases the lock (step 1007), and the process ends.

### (Exemplary Modification 2)

The following describes exemplary modification 2, which is another exemplary modification of the first exemplary embodiment. In exemplary modification 2, a locking process with details different from the lock details is performed during the grace period of exemplary modification 1. In the following, the process performed during the grace period may be referred to as the alternative lock details, and the grace period may be referred to as the alternative lock period. In the lock details table according to exemplary modification 2, lock details, an alternative lock period, and alternative lock details are stored in the storage device 54 (see FIG. 3) in association with each service. The alternative lock details indicate a locking process to be performed during the alternative lock period. The alternative lock details are determined in advance by the service provider, for example. The alternative lock details may be details to execute a portion of the functions indicated as functions to be stopped in the lock details.

The lock details table according to exemplary modification 2 is stored in the storage device 54 (see FIG. 3) of the lock server 50 (see FIG. 3). The service lock details management unit 740 (see FIG. 4) of the image processing apparatus 70 (see FIG. 4) acquires the lock details table from the lock server 50. The lock details table is stored in the storage device 74 (see FIG. 2) of the image processing apparatus 70 by the service lock details management unit 740.

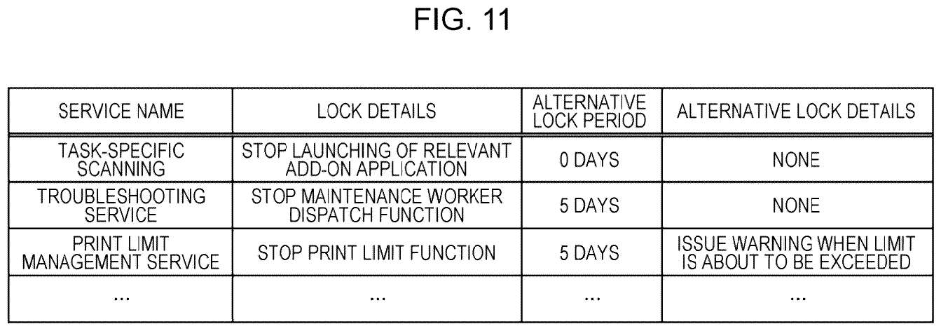

FIG. 11 is a diagram illustrating an example of the lock details table according to exemplary modification 2. Specifically, for “Task-specific scanning”, “Stop launching of relevant add-on application” is associated as the lock details, “0 days” is associated as the alternative lock period, and “None” is associated as the alternative lock details. For the “Troubleshooting service”, “Stop maintenance worker dispatch function” is associated as the lock details, “5 days” is associated as the alternative lock period, and “None” is associated as the alternative lock details. Additionally, for “Print limit management”, “Stop print limit function” is associated as the lock details, “5 days” is associated as the alternative lock period, and “Issue warning when limit is about to be exceeded” is associated as the alternative lock details.

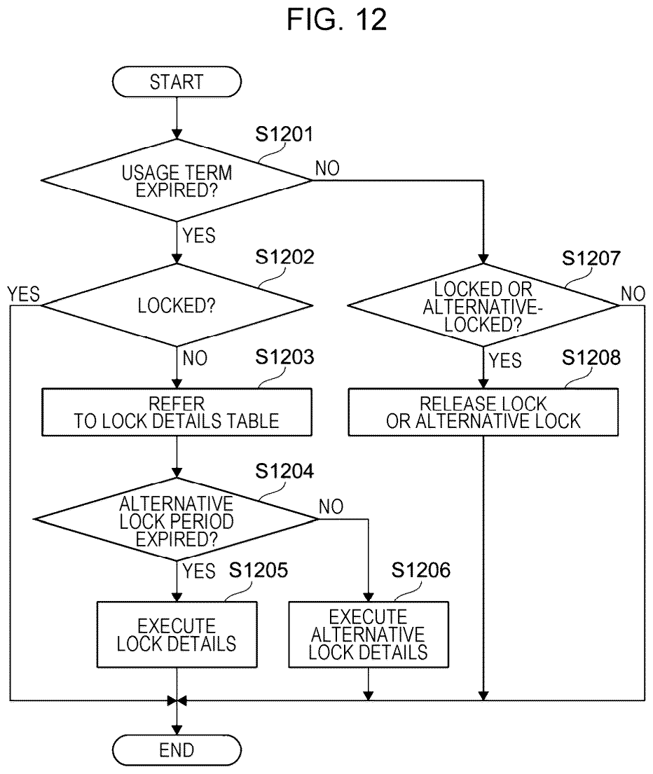

FIG. 12 is a flowchart illustrating an example of a process whereby the image processing apparatus 70 locks a function upon expiration of the usage term of a service. The CPU 71 of the image processing apparatus 70 refers to the usage term table stored in the storage device 74 (see FIG. 2) of the image processing apparatus 70, and determines whether or not the usage term of a service is expired (step 1201). If the usage term of a service is expired (step 1201, YES), the CPU 71 determines whether or not the service is already locked (step 1202). If the service with the expired usage term is not locked (step 1202, NO), the CPU 71 refers to the lock details table associated with the service with the expired usage term (step 1203). The CPU 71 then determines whether or not the alternative lock period is expired (step 1204). If the alternative lock period is expired (step S1204, YES), the CPU 71 executes the lock details (step 1205), and the process ends.

In step 1204, if the alternative lock period is not expired (step S1204, NO), the CPU 71 executes the alternative lock details (step 1206), and the process ends. Also, in step 1202, if the service with the expired usage term is already locked (step 1202, YES), the process ends immediately.

Also, in step 1201, if the usage term is not expired (step 1201, NO), the CPU 71 determines whether or not the service is already locked or alternative-locked (step 1207). If the service is neither locked nor alternative-locked (step 1207, NO), the process ends immediately. If the service is locked or alternative-locked (step 1207, YES), the CPU 71 releases the lock or alternative lock (step 1208), and the process ends.

### Second Exemplary Embodiment

In the second exemplary embodiment, the lock details are changed according to the user who is logged in to the image processing apparatus. Note that functions similar to those of the first exemplary embodiment will be indicated using similar signs, and a description of such functions will be reduced or omitted in the following.

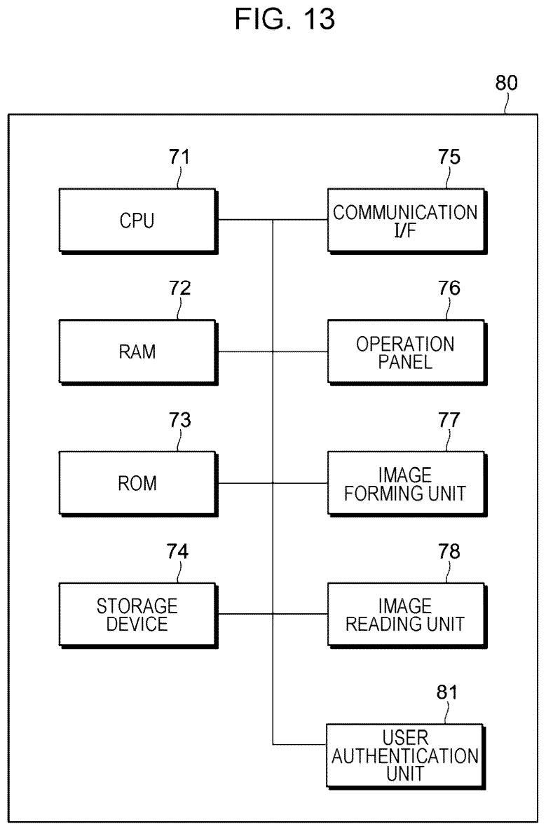

FIG. 13 is a diagram illustrating an example of a hardware configuration of an image processing apparatus 80 according to the second exemplary embodiment. The hardware configuration of the image processing apparatus 80 according to the second exemplary embodiment includes the hardware configuration of the image processing apparatus 70 according to the first exemplary embodiment, with the addition of a user authentication unit 81. The user authentication unit 81 is a device used to identify users. Specifically, one example thereof is an IC card reader that reads an ID card carried by a user.

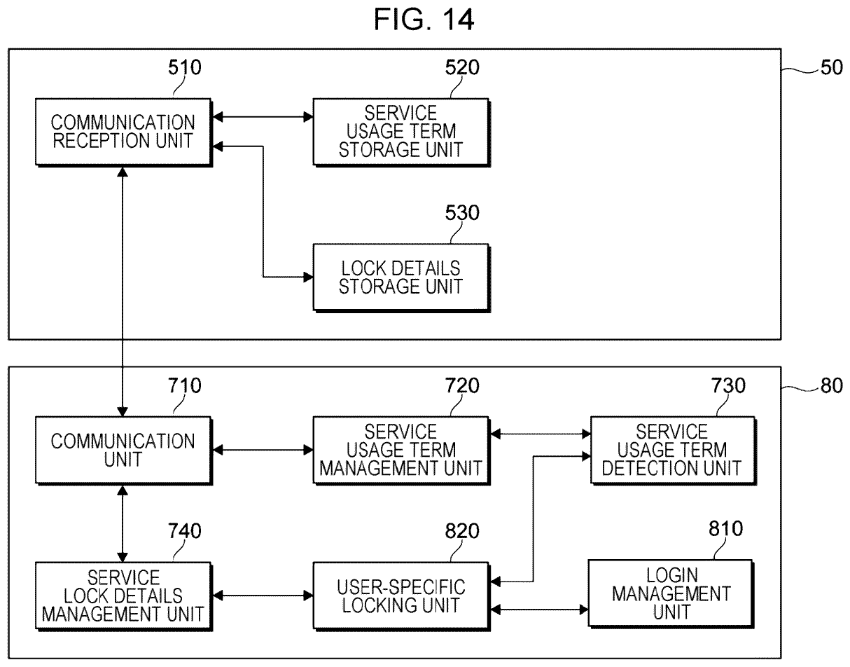

FIG. 14 is a diagram illustrating an example of functional configurations of the image processing apparatus 80 and the lock server 50 according to the second exemplary embodiment. The image processing apparatus 80 includes a user-specific locking unit 820 instead of the service locking unit 750 of the image processing apparatus 70 according to the first exemplary embodiment. The image processing apparatus 80 also includes a login management unit 810. Note that as described above, some or all of the functions executed by the image processing apparatus 80 may also be executed by the management server 60.

The login management unit 810 authenticates the user logging in to the image processing apparatus 80. In the present exemplary embodiment, when logging in to the image processing apparatus 80, user authentication is performed by the user authentication unit 81 provided in the image processing apparatus 80. Specifically, the user is identified and logged in by causing the IC card reader provided in the image processing apparatus 80 to read the ID card carried by the user. Note that the method of user authentication is not particularly limited, and for example, the user may also be authenticated by entering identification information that identifies the user and a password into the operation panel 76.

In the present exemplary embodiment, a user is classified as a machine administrator or a general user. However, user classification is not limited thereto, and users may also be classified into three or more classes. A machine administrator is assumed to be a person who manages the image processing apparatus 80. For example, the machine administrator may be the person responsible for contracting additional services for the image processing apparatus 80. Note that a general user is a user other than the machine administrator, and is assumed to be a person who uses the image processing apparatus 80. A user classification is assigned to each user, and user identification information and the user classification are stored in association with each other in the storage device 74 (see FIG. 13) of the image processing apparatus 80. The user classification is assigned by the machine administrator of the image processing apparatus 80, for example.

The user-specific locking unit 820 changes the functions to be stopped according to the user who is operating the image processing apparatus 80. The user-specific locking unit 820 acquires identification information for the logged-in user, acquires lock details according to the logged-in user, and changes the functions to be stopped according to the logged-in user.

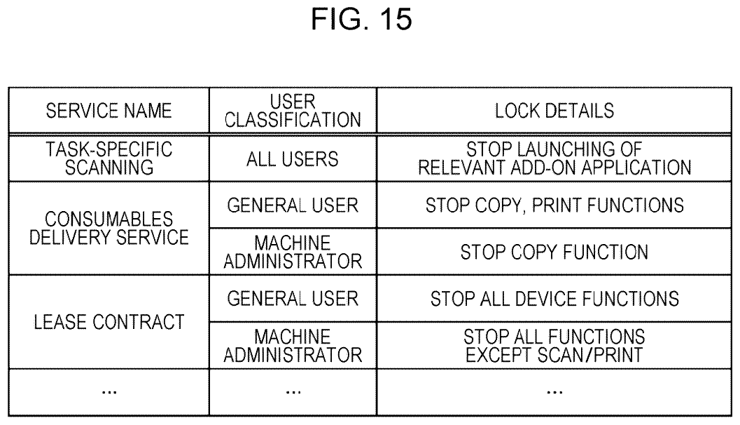

FIG. 15 is a diagram illustrating an example of the lock details table according to the second exemplary embodiment. The lock details table is provided with a “Service name” and a “User classification” as identification information identifying the user who operates the image processing apparatus, and “Lock details” are defined in association with the “Service name” and the “User classification”. Specifically, for “Task-specific scanning”, “All users” is associated as the user classification, and “Stop launching of relevant add-on application” is associated as the lock details. Also, for the “Consumables delivery service”, “General user” and “Machine administrator” are associated as user classifications. In this case, for the “Consumables delivery service” and the user classification “General user”, “Stop copy, print functions” is associated as the lock details. Also, for the “Consumables delivery service” and the user classification “Machine administrator”, “Stop copy function” is associated as the lock details.

For “Lease contract”, “General user” and “Machine administrator” are associated as user classifications. In this case, for a lease contract and the user classification “General user”, “Stop all device functions” is associated as the lock details. Also, for a lease contract and the user classification “Machine administrator”, “Stop all functions except scan/print” is associated as the lock details.

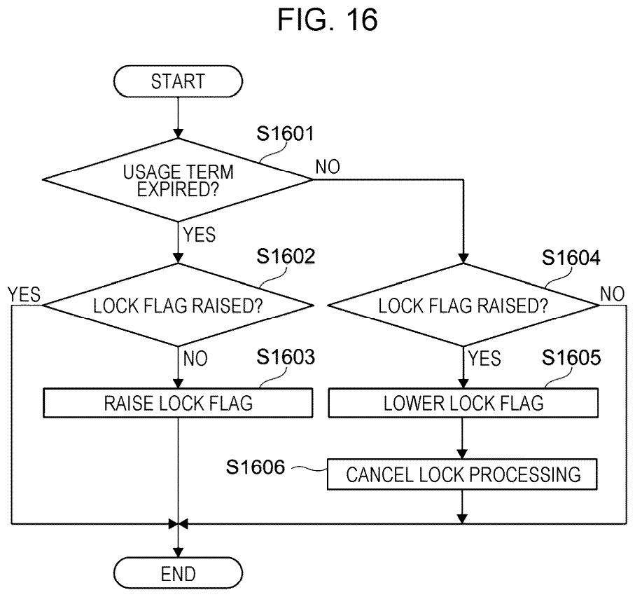

FIG. 16 is a flowchart illustrating an example of a process for periodically checking the usage term. When a timing at which to perform a periodic usage term check is reached, the CPU 71 of the image processing apparatus 80 determines whether or not the usage term is expired (step 1601). If the usage term is expired (step 1601, YES), the CPU 71 determines whether or not a lock flag is raised (step 1602). If the lock flag is raised (step 1602, YES), the process ends immediately. In step 1602, if the lock flag is not raised (step 1602, NO), the CPU 71 raises the lock flag (step 1603), and the process ends.

In step 1601, if the usage term is not expired (step 1601, NO), the CPU 71 determines whether or not the lock flag is raised (step 1604). If the lock flag is not raised (step 1604, NO), the process ends immediately. In step 1604, if the lock flag is raised (step 1604, YES), the CPU 71 lowers the lock flag (step 1605), and the process ends. Additionally, if the locking process is currently being executed, the CPU 71 cancels the locking process (step 1606), and the process ends.

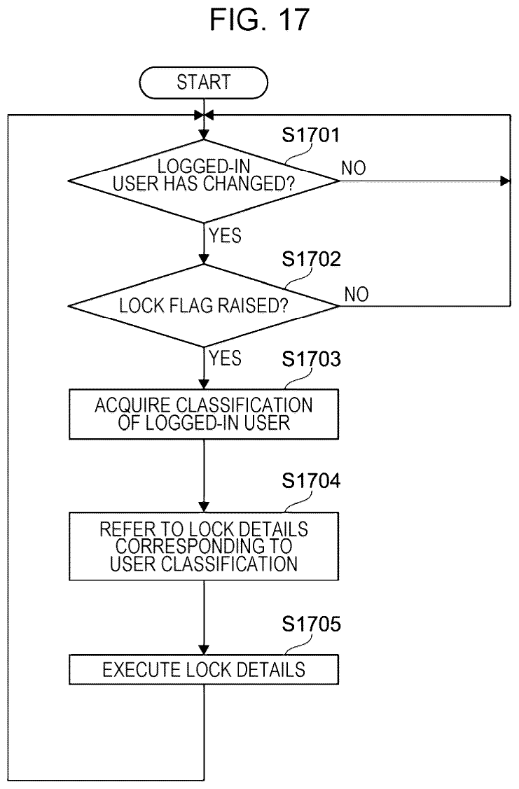

FIG. 17 is a diagram illustrating an example of the flow of a process whereby a lock is applied to a newly logged-in user when the logged-in user changes. The CPU 71 of the image processing apparatus 80 determines whether or not the logged-in user has changed (step 1701). If the logged-in user has not changed (step 1701, NO), the process returns to step 1701. If the logged-in user has changed (step 1701, YES), the CPU 71 determines whether or not the lock flag is raised (step 1702). If the lock flag is not raised (step 1702, NO), the process returns to step 1701. In step 1702, if the lock flag is raised (step 1702, YES), the CPU 71 acquires the classification of the logged-in user (step 1703). Then CPU 71 then references the lock details corresponding to the user classification (step 1704). The CPU 71 executes the referenced lock details (step 1705), and then returns to step 1701.

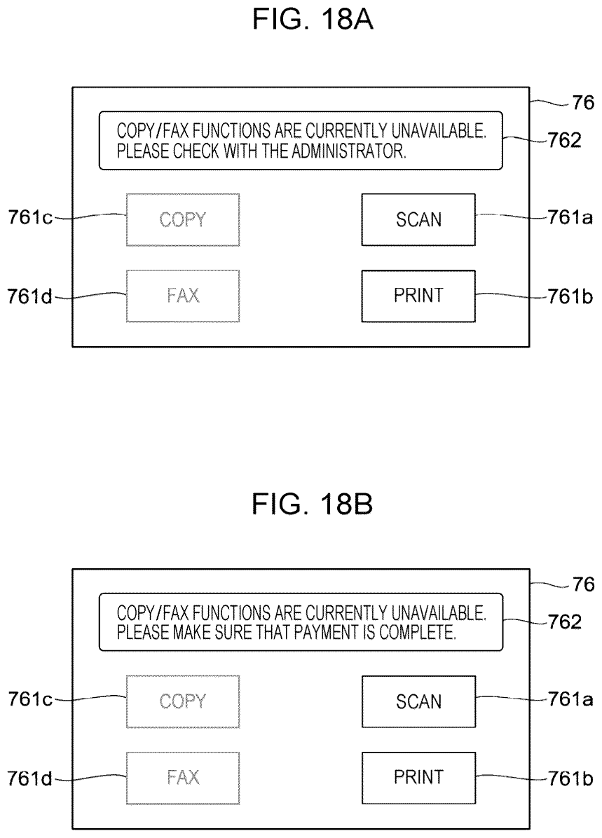

FIGS. 18A and 18B each illustrate an example of a display screen on the operation panel 76. FIG. 18A is an example of a display screen in the case where the logged-in user is a general user. FIG. 18B is an example of a display screen in the case where the logged-in user is a machine administrator. The user operates the image processing apparatus 80 by touching the display screen of the operation panel 76 illustrated in FIG. 18A. As illustrated in FIG. 18A, instruction buttons 761a to 761d enabling the user to give instructions to the image processing apparatus 80 are displayed on the operation panel 76. A message field 762 for displaying a message to the user is also displayed on the operation panel 76.

Also, in this case, the display appearance of the instruction button 761a and the instruction button 761b is different from the display appearance of the instruction button 761c and the instruction button 761d. The instruction button 761c and the instruction button 761d are displayed with a grayed-out display appearance. Note that grayed-out herein refers to a display appearance indicating that an input clement displayed on an operation screen of a computer has been set to a temporarily inoperable/non-selectable state. This allows the user to understand that the functions launched by the instruction buttons 761c and 761d are in a stopped state. Additionally, the following message is displayed in the message field 762: “Copy/fax functions are currently unavailable. Please check with the administrator.” In this way, the image processing apparatus 80 notifies the user of which functions are stopped from among the functions related to services.

In FIG. 18B, the content displayed in the message field 762 is different as compared to FIG. 18A. The following message is displayed in the message field 762: “Copy/fax functions are currently unavailable. Please make sure that payment is complete.” In the case where the logged-in user is an administrator, for example, a procedure that has not been completed as part of the renewal procedure may be displayed to prompt the machine administrator to perform the renewal procedure.

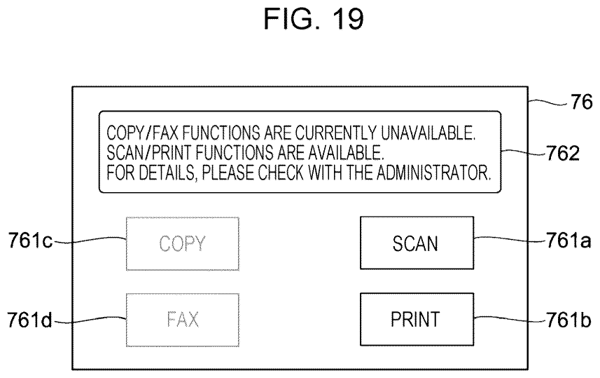

FIG. 19 is another example of the display screen on the operation panel 76. In FIG. 19, unlike FIGS. 18A and 18B, the following is stated in the message field 762: “Copy/fax functions are currently unavailable. Scan/print functions are available. For details, please check with the administrator.” In this way, the CPU 71 displays the functions which are stopped from among the functions related to services and the functions which are not stopped from among the functions related to services on the operation panel 76 of the image processing apparatus 80.

As detailed above, in the first exemplary embodiment, by defining stopped function information for each service, in the “Fax document folder sorting service”, for example, the sorting of documents received by facsimile is executed even after the service usage term expires. This makes it possible to resume the “Fax document folder sorting service” with sorting having also been executed for fax documents received outside the service usage term.

In the second exemplary embodiment, stopped function information is further defined for each user classification. As an example, the renewal procedure may involve filling in user information and the like on a contract form printed by the 80 image processing unit, and sending the completed form by facsimile. In this case, the renewal procedure would be difficult if the print function and the facsimile function are stopped. In the second exemplary embodiment, stopped function information is defined according to the classification of the logged-in user, and thus the print function and the facsimile function may be made available for execution in the case in which the logged-in user is a machine administrator, for example. This allows a machine administrator to perform the renewal procedure easily even after the service usage term is expired, while also prohibiting usage of services by general users.

As detailed above, according to the exemplary embodiments, it is possible to define, for each service, processes to be stopped when the usage term expires without a renewal procedure being performed. Accordingly, this makes it possible to resume services smoothly compared to the case of stopping services indiscriminately.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### (Appendix)

(((1)))

A service management system comprising:

at least one processor configured to:

acquire a usage term of a service related to an image processing apparatus;

acquire stopped function information defined for each service, the stopped function information indicating which function, from among functions related to the service, is to be stopped when the usage term expires; and

stop, when the usage term of the service expires, usage of the function included in the stopped function information defined for the service with the expired usage term.

(((2)))

The service management system according to (((1))), wherein the at least one processor is configured to resume the function included in the stopped function information if a renewal process for the service is completed after the function included in the stopped function information is stopped.

(((3)))

The service management system according to (((1))) or (((2))), wherein the at least one processor is configured to acquire the usage term periodically.

(((4)))

The service management system according to (((3))), wherein the at least one processor is configured to shorten a cycle for acquiring the usage term once the usage term expires.

(((5)))

The service management system according to (((3))) or (((4))), wherein the at least one processor is configured to acquire the usage term in response to a user instruction.

(((6)))

The service management system according to (((1))) or (((2))), wherein the at least one processor is configured to change the function to be stopped according to a user who is operating the image processing apparatus.

(((7)))

The service management system according to (((6))), wherein:

the user is given a classification that classifies the user as a machine administrator who manages the image processing apparatus or as a general user who uses the image processing apparatus, and the at least one processor is configured to change the function to be stopped according to the classification of the user.

(((8)))

The service management system according to (((6))), wherein the stopped function information is predetermined on a basis of identification information that identifies the user operating the image processing apparatus, and the service.

(((9)))

The service management system according to (((1))) or (((2))), wherein:

the stopped function information includes a grace period, which is a period until the function is stopped after the usage term expires, and

the at least one processor is configured to stop the function included in the stopped function information after the grace period expires.

(((10)))

The service management system according to (((9))), wherein the service is a function expansion service that expands functionality of the image processing apparatus or a maintenance service for providing maintenance management of the image processing apparatus, the maintenance service having a longer grace period than the function expansion service.

(((11)))

The service management system according to (((9))), wherein, during the grace period, a portion of the function included in the stopped function information is executed.

(((12)))

The service management system according to (((1))) or (((2))), wherein upon accepting, from a user, an instruction to execute the service with the expired usage term, the at least one processor is configured to notify the user of the function which is stopped from among the functions related to the service.

(((13)))

The service management system according to (((12))), further comprising:

a display device that presents information to the user, wherein:

the at least one processor is configured to display, on the display device, the function which is stopped from among the functions related to the service and the function which is not stopped from among the functions related to the service.

(((14)))

A program causing a computer to execute a process comprising:

acquiring a usage term of a service related to an image processing apparatus;

acquiring stopped function information defined for each service, the stopped function information indicating which function, from among functions related to the service, is to be stopped when the usage term expires; and

stopping, when the usage term of the service expires, usage of the function included in the stopped function information defined for the service with the expired usage term.

What is claimed is:

1. A service management system comprising:
at least one processor configured to:
acquire a usage term of a service related to an image processing apparatus;
acquire stopped function information defined for each service, the stopped function information indicating which function, from among functions related to the service, is to be stopped when the usage term expires; and
stop, when the usage term of the service expires, usage of the function included in the stopped function information defined for the service with the expired usage term.

2. The service management system according to claim 1, wherein the at least one processor is configured to resume the function included in the stopped function information if a renewal process for the service is completed after the function included in the stopped function information is stopped.

3. The service management system according to claim 1, wherein the at least one processor is configured to acquire the usage term periodically.

4. The service management system according to claim 3, wherein the at least one processor is configured to shorten a cycle for acquiring the usage term once the usage term expires.

5. The service management system according to claim 3, wherein the at least one processor is configured to acquire the usage term in response to a user instruction.

6. The service management system according to claim 1, wherein the at least one processor is configured to change the function to be stopped according to a user who is operating the image processing apparatus.

7. The service management system according to claim 6, wherein:
the user is given a classification that classifies the user as a machine administrator who manages the image processing apparatus or as a general user who uses the image processing apparatus, and the at least one processor is configured to change the function to be stopped according to the classification of the user.

8. The service management system according to claim 6, wherein the stopped function information is predetermined on a basis of identification information that identifies the user operating the image processing apparatus, and the service.

9. The service management system according to claim 1, wherein:
the stopped function information includes a grace period, which is a period until the function is stopped after the usage term expires, and
the at least one processor is configured to stop the function included in the stopped function information after the grace period expires.

10. The service management system according to claim 9, wherein the service is a function expansion service that expands functionality of the image processing apparatus or a maintenance service for providing maintenance management of the image processing apparatus, the maintenance service having a longer grace period than the function expansion service.

11. The service management system according to claim 9, wherein, during the grace period, a portion of the function included in the stopped function information is executed.

12. The service management system according to claim 1, wherein upon accepting, from a user, an instruction to execute the service with the expired usage term, the at least one processor is configured to notify the user of the function which is stopped from among the functions related to the service.

13. The service management system according to claim 12, further comprising:
a display device that presents information to the user, wherein:
the at least one processor is configured to display, on the display device, the function which is stopped from among the functions related to the service and the function which is not stopped from among the functions related to the service.

14. A service management method comprising:
acquiring a usage term of a service related to an image processing apparatus;
acquiring stopped function information defined for each service, the stopped function information indicating which function, from among functions related to the service, is to be stopped when the usage term expires; and
stopping, when the usage term of the service expires, usage of the function included in the stopped function information defined for the service with the expired usage term.

15. A non-transitory computer readable medium storing a program causing a computer to execute a process comprising:
acquiring a usage term of a service related to an image processing apparatus;
acquiring stopped function information defined for each service, the stopped function information indicating which function, from among functions related to the service, is to be stopped when the usage term expires; and
stopping, when the usage term of the service expires, usage of the function included in the stopped function information defined for the service with the expired usage term.
